(19) United States
(12) Patent Application Publication
(10) Pub. No.: US 2008/0007736 A1
(43) Pub. Date: Jan. 10, 2008

(54) Apparatus For The Three-Dimensional Scanning Of Objects

(76) Inventor: Hubert Kammer, Bischoffen (DE)

Correspondence Address: ST. ONGE STEWARD JOHNSTON & REENS, LLC, 986 BEDFORD STREET, STAMFORD, CT, 06905-5619, US

(21) Appl. No.: 11/836,479

(22) Filed: Aug. 9, 2007

Related U.S. Application Data
(63) Continuation of application No. PCT/EP06/01146, filed on Feb. 9, 2006.

(30) Foreign Application Priority Data
Feb. 10, 2005 (DE) 10 2005 006 069.2

(51) Int. Cl. G01B 11/30

(52) U.S. Cl. 356/606

(57) ABSTRACT

The invention relates to an apparatus for three-dimensional scanning of objects that are moved past a stationary optical scanner, the apparatus including a six-legged object-carrier configured as a hexapod and serving to record the object to be scanned. In order to create an apparatus that not only is economical in terms of construction but also allows easy operation in executing a scanning process, it is proposed that the object should be positioned on a turntable carried by the hexapod.

### CROSS-REFERENCE TO RELATED APPLICATIONS

The present application is a continuation of pending International patent application PCT/EP2006/001146 filed on Feb. 9, 2006 which designates the United States and claims priority from German patent application 10 2005 006 069.2 filed Feb. 10, 2005, the content of which is incorporated herein by reference.

### FIELD OF THE INVENTION

The invention relates to an apparatus for the three-dimensional scanning of an object that is moved past a stationary optical sensor, said apparatus taking the form of a hexapod or six-legged object-carrier and serving to photograph objects to be scanned.

### BACKGROUND OF THE INVENTION

Various methods for scanning three-dimensional objects are known in the art, in which the object to be scanned is moved past a stationary optical sensor, such as a light stripe sensor. In these state-of-the-art methods, the information captured by the scanner is evaluated at the end of the entire scanning process and is reproduced as a three-dimensional representation. In particular in scanning unknown objects, in which no comparison can be made between stored nominal values and currently captured actual values, the danger exists that in fact all measurement points of the object to be scanned were captured by the scanner. In the evaluation at the end of the scanning process, if it is established that individual partial areas of the object have not been captured, or have not been completely captured, it is almost impossible to address with exactitude these areas that are in the micrometer range in order to conduct a careful post-scan.

For carrying and guiding the object to be scanned, US 2003/0081717 A1 for instance reports on use of a hexapod or six-legged object-carrier, which because of its geometric design allows the object to be moved in all six degrees of freedom. The structure and operation of these hexapods, familiar in the art, whose legs comprise servo-driven spindle motors, is however extremely costly and complex.

### SUMMARY OF THE INVENTION

Consequently it is the object of the present invention to create a cost-efficient, easily operated apparatus for carrying out scanning operations.

This object can be achieved thanks to the invention in a manner characterized in that the object is positioned on a turntable supported on the hexapod. By using the additional turntable, which is positioned on the hexapod, it is particularly easy to move the object to be scanned past the optical sensor while using the six degrees of freedom of the object-carrier. Using the additional turntable allows an easy, rapid 360-degree rotation of the object to be scanned, whereas the rotation of an object-carrier borne only by the six hexapod legs is restricted to 30 to 40 degrees, because in this case the hexapod legs become obstructive of one another.

According to a practical embodiment of the invention, it is proposed that the optical sensor should be configured as a light stripe sensor. This type of sensor has proven itself in the scanning of three-dimensional objects.

To ensure an inexpensive structure and handling of the object-carrier configured as a hexapod, the inventive hexapod takes the form of a manually displaceable passive hexapod, whose legs are preferably designed to be extensible only longitudinally. Owing to the proposed manual adjustability, it is possible to dispense with the use of expensive, high-maintenance servo and spindle drives.

According to the invention, the adjustable length of the hexapod legs can be achieved preferably by a spring mechanism installed in the legs. A possible alternative is to construct the legs of the hexapod to be hydraulically or pneumatically length-adjustable.

To ascertain the spatial location of the object to be scanned in relation to the optical sensor, measurement receptors that capture the movements of these components are located both on the hexapod legs and on the turntable of the object-carrier. These measurement receptors are preferably designed as encoders that register metering pulses.

It is further proposed with the invention that the turntable should comprise a locking apparatus to secure the object to be scanned, in order to fix the object to be scanned on the object-carrier and thus in relation to the optical sensor. According to a first inventive embodiment, the locking apparatus takes the form of a gripping apparatus.

Finally, it is proposed with the invention that according to an alternative embodiment, the locking apparatus should be configured as a magnetically acting stopping apparatus.

Additional characteristics and advantages of the apparatus can be seen from the appended drawings, which depict in exemplary manner an embodiment of an inventive apparatus for three-dimensional scanning of objects that are moved past a stationary optical sensor.

### BRIEF DESCRIPTION OF THE DRAWINGS

FIG. 1 is apparatus for the three-dimensional scanning of objects according to an exemplary embodiment of the present invention.

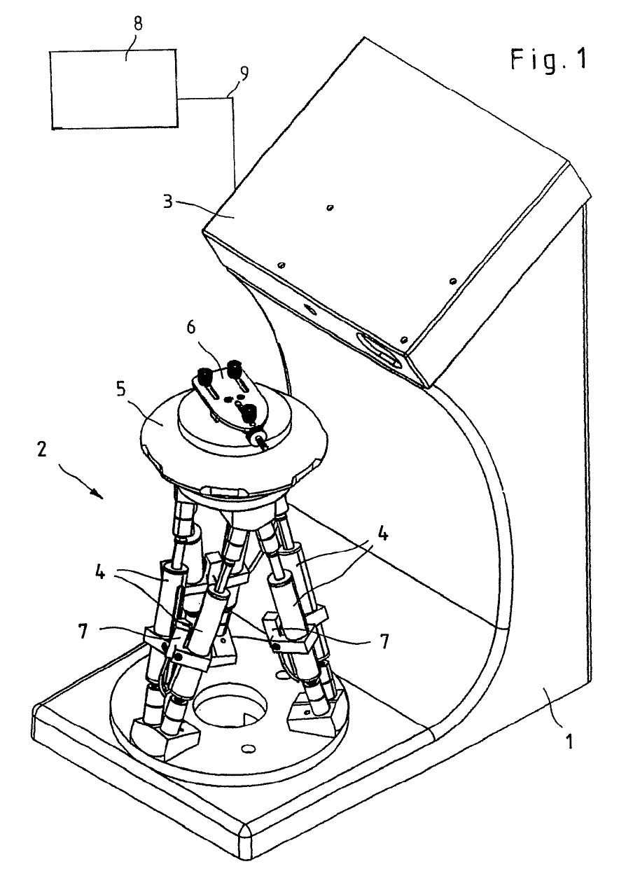

### DETAILED DESCRIPTION OF THE INVENTION

The apparatus for three-dimensional scanning of objects moved past a stationary optical sensor, shown in the illustration, consists essentially of a frame 1, an object-carrier 2 positioned on said frame 1, as well as an optical sensor 3 that is positioned stationarily in the frame 1 and points toward the object-carrier 2.

The object-carrier 2 configured as a hexapod consists of six legs 4 that can be adjusted exclusively in terms of length and a turntable 5 that is supported by the legs 4 of the hexapod. As can be seen from the illustrations, the turntable 5 further comprises a locking apparatus 6 for securing the object that is to be scanned.

The combination of the paired arrangement of the legs 4, which can be adjusted only in terms of length and are set off at an 120 degree angle from one another, with the turntable 5 that is supported by the legs 4 allows a movement of an object fixed in the locking apparatus 6 in all six degrees of freedom in relation to the stationary optical sensor 3 that is positioned in the frame 1. In order, on the one hand, to facilitate the operation and, on the other hand, to minimize the manufacturing and maintenance costs, the hexapod is configured as a passive, that is, exclusively manually adjustable hexapod.

In the illustrated embodiment, the locking apparatus 6 takes the form of a gripping apparatus in which an object that is to be scanned can be secured by clamping. It is of course also possible to configure the locking apparatus 6 as a magnetically operated holding apparatus, for instance.

To make it possible to capture the location of the object that is to be scanned, which is positioned on the object-carrier 2, in relation to the optical sensor 3, sensing elements 7, which register the movements of these components 4, 5, are positioned on the legs 4 of the hexapod and on the turntable 5. These sensing elements 7 are preferably configured as encoders that record metering pulses.

The apparatus for three-dimensional scanning of objects moved past a stationary optical sensor operates as follows.

To start the scanning process, the object to be scanned, for instance a dental imprint of a jaw, is fixed on the locking apparatus 6 of the object-carrier 2 in order to connect the carrier immovably with the object-carrier 2.

The optical sensor 3, preferably in the form of a light stripe sensor that takes measurements in two dimensions, is positioned stationarily in the frame 1 of the scanning apparatus in such a way that it is always pointed toward the object secured in the locking apparatus 6.

Then the object to be scanned, by turning the turntable 5 and by shortening and lengthening the extensible legs 4 of the hexapod is moved past the optical sensor 3 in such a way that said scanner captures the object to be scanned on all sides.

To make it possible for the user of the scanning apparatus to review the scanning process for completeness, the metering pulses recorded by the sensing elements 7 on the legs 4 of the hexapod as well as on the turntable 5 are translated by means of software into three-dimensional spatial coordinates, which reflect the position of the object to be scanned in relation to the optical sensor 3. These three-dimensional spatial coordinates are set in correlation with the respective corresponding two-dimensional information of the optical scanner 3 and from these correlated data a three-dimensional depiction is produced immediately, in real time, which can be shown to the user of the scanning apparatus, for instance, directly on a monitor 8, which is connected with the scanning apparatus by a data line 9.

This immediate depiction of the scanning process as three-dimensional depiction allows the user immediately, during the scanning operation, to verify whether the object to be scanned was scanned completely, that is, seamlessly. If the user, in observing the indicated three-dimensional, observe that gaps are still present in the measurement data, then this depiction shows him directly exactly where the measurement data gaps are located, so that these incomplete portions can be immediately and deliberately rescanned once again.

The illustrated and described apparatus for three-dimensional scanning of objects moved past a stationary optical sensor is thus characterized in that it allows the user an immediate review of the scanning process for completeness. In addition the scanning apparatus is simple to operate and, because of the manual operation of the object-carrier, economical to produce.

1. An apparatus for three-dimensional scanning of objects that are moved past a stationary optical sensor, said apparatus comprising a six-legged object-carrier in the form of a hexapod that serves to record the object that is to be scanned characterized in that the object is positioned on a turntable carried on one of the hexapods.

2. An apparatus according to claim 1, characterized in that the optic sensor is configured as a light stripe sensor.

3. An apparatus according to claim 1, characterized in that the hexapod is configured as a passive hexapod that can be adjusted only manually.

4. An apparatus according to claim 1, characterized in that the legs of the hexapod are configured so that they are adjustable exclusively in terms of length.

5. An apparatus according to claim 4, characterized in that legs of the hexapod can be adjusted by means of a spring mechanism.

6. An apparatus according to claim 4, characterized in that the legs of the hexapod are configured so that their length can be adjusted hydraulically.

7. An apparatus according to claim 4, characterized in that legs of the hexapod are configured so that their length can be adjusted pneumatically.

8. An apparatus according to claim 1, characterized in that sensing elements are situated on the legs of the hexapod and on the turntable to detect the movements of these components.

9. An apparatus according to claim 4, characterized in that the sensing elements are configured as encoders that record metering pulses.

10. An apparatus according to claim 1, characterized in that the turntables comprises a locking apparatus to secure the object that is to be scanned.

11. An apparatus according to claim 10, characterized in that the locking apparatus is configured as a gripping apparatus.

12. An apparatus according to claim 10, characterized in that the locking apparatus is configured as a magnetically acting holding apparatus.

13. An apparatus according to claim 1, characterized by a monitor for immediate three-dimensional depiction of the scanned object portion.
